(19) United States
(12) Patent Application Publication
(10) Pub. No.: US 2011/0014586 A1
(43) Pub. Date: Jan. 20, 2011

(54) CERAMIC ONE-PIECE DENTAL IMPLANT

(75) Inventors: Lars Jorneus, Frillesas (SE); Christer Fassberg, Stenkullen (SE)

Correspondence Address: KNOBBE MARTENS OLSON & BEAR LLP, 2040 MAIN STREET, FOURTEENTH FLOOR, IRVINE, CA, 92614, US

(73) Assignee: Nobel Biocare Services AG, Zurich-Flughafen (CH)

(21) Appl. No.: 12/600,243

(22) PCT Filed: May 16, 2008
(86) PCT No.: PCT/EP2008/003963

§ 371 Date: Oct. 1, 2010

(30) Foreign Application Priority Data
May 16, 2007 (SE) 0701199-2

(51) Int. Cl. A61C 8/00; A61C 13/12

(52) U.S. Cl. 433/173; 433/172; 433/201.1

(57) ABSTRACT

A ceramic one-piece implant is provided that comprises a first portion and a second portion that are integrally formed with each other. The first portion can be arranged at a coronal end of the implant for fitting engagement with a dental restoration to the implant. The second portion can contiguously adjoin the first portion at a coronal edge. Further, the second portion can have a width and be arranged apically from the coronal end of the implant. The second portion can also be devised for arrangement in epithelial contact with soft tissue upon implantation of the dental implant. Furthermore, a curvature including the coronal edge can be adjustable by removal of material at least from the second portion while the width of the shoulder is substantially maintained.

### PRIORITY INFORMATION

This application is a U.S. National Phase of International Application No. PCT/EP2008/003963, filed May 16, 2008, which claims priority to Swedish Patent Application No. SE 0701199-2, filed May 16, 2007, each of which is hereby incorporated by reference in its entirety.

### BACKGROUND

1. Field of the Inventions

This invention pertains in general to the field of dental implants. More particularly the invention relates to ceramic one-piece dental implants.

2. Description of the Related Art

It is earlier known to have waist shaped abutment portions on dental implants. For instance WO05072639A of the same applicant as the present application discloses a transmucosal component for a dental implant intended to support a prosthetic restoration. The transmucosal component has a waist-shaped or inwardly narrowed portion having contact with a surface whose distance in longitudinal direction corresponds to a required width of adjoining soft tissue. The waist-shaped or inwardly narrowed portion reduces a necessary height of a transmucosal component of the dental implant and generates a volume for a stabilizing and retentive belt of soft tissue. The distance in the longitudinal direction along the contact surface of the waist-shaped or inwardly narrowed portion corresponds to the required width of adjoining soft tissue. Thus a dental unit is formed, which is well anchored in the jaw bone and gum, and which permits an excellent and durable degree of integration between the jaw bone or gum and the adjoining portions of the transmucosal component or fixture, as well as avoids bone resorption and subsidence tendencies.

The waist shaped abutment portions are provided as two-piece designs. Two-piece designs offer the advantage of being flexible with regard to different patient topographies by choosing suitable abutments that are close to the specific patient topography. In such a manner, a single type of implant covers with interchangeable abutment portions a wide range of patient topographies. However, the integrity of two-piece designs may be disadvantageous with regard to mechanical strength. Two-piece designs also have the disadvantage of a seam between the abutment and the implant. This seam is often not sealed, especially when subjected to loads. The subsequent leakage may induce inflammations in the surrounding soft tissue.

Curved shaped, scalloped dental implants are known from WO2006081239 of Wohrle, disclosing a dental implant assembly for supporting a dental prosthesis. The assembly comprises a dental implant and an abutment. The dental implant comprises a body portion, a collar portion and a central bore. The body portion is located at an apical end of the dental implant and is configured to lie at least substantially below a crest of a patient's jawbone. The collar portion is located at a coronal end of the dental implant and forms a top surface which defines an outer edge that has a generally scalloped shape. An abutment includes a lower portion and is configured to fit within the central bore and an upper portion that extends above the top surface of the implant. A final restoration is configured to fit over the abutment. The final restoration and abutment are configured such that when they are positioned on the dental implant, at least a portion of the top surface is exposed. The implants disclosed in dental implants are known by WO2006081239 also suffer from the generic disadvantages of two-piece implants.

Furthermore, even if a broad assortment of abutments is available, it will not be possible to cover all patient topographies with high precision. In some situations, the dentist chooses abutments as a compromise between available abutments, aesthetics and function of the implant. Hence, dental restorations based on two-piece implants may not always be satisfactory, at least from an aesthetic point of view.

In order to provide dental implants without such a disadvantageous seam, one-piece dental implants were developed. For instance WO03103527, of the same applicant as the present application, discloses a dental implant for supporting a dental prosthesis. The dental implant has a body portion and an abutment portion made of one integral piece. The dental implant further includes a roughened surface. When the dental implant is installed into a patient's jawbone, the roughened surface extends above a crest of the jawbone. In this manner the dental implant disclosed in WO03103527 provides good osseointegration and enhanced tissue attachment between the dental implant and a patient's gum. However, it may not be practically feasible to provide specific solutions to patient specific topographies, such as with two-part implants. As one-piece implants exclude exchangeable portions, such as abutment portions, a wide range of implants has to be provided for all possible patient situations and topographies. Even with a broad assortment of differently shaped dental implants, it may prove difficult to cover all patient topographies with high precision.

When attaching a crown, a temporary crown, bridge or another dental restoration to a dental implant, it is affixed to the dental implant by means of dental cement or bonding agent. In order to avoid a gap between the dental implant and the abutting dental restoration, excess dental cement or bonding agent is used, which flows out of the gap between the two elements, before it hardens. The excess dental cement or bonding agent runs down the known implants and may be difficult to remove, or even forms pockets in which the dental cement or bonding agent is beyond reach and may cause various issues, such as inflammation, failure of the implant, etc.

Another one-piece dental implant is disclosed in WO0245615, which includes a fixture and an abutment in a single implant body. The implant comprises an upper abutment portion on which a denture is fixed, a fixture portion implanted in the jawbone and forming single or double threads and a settling portion formed between the abutment portion and the fixture portion. However, also this implant suffers from disadvantages with regard to lack of flexibility. Furthermore, the one-piece dental implant does not have any adjusting allowances to specific situations of a patient's anatomy. A preparation line passes directly to a waist portion of the dental implant disclosed in WO0245615. This contributes to the formation of pockets filled with dental cement, as described above. Removal of such dental cement filled pockets is practically difficult.

Hence, an improved ceramic one-piece dental implant would be advantageous, and in particular a ceramic one-piece dental implant providing advantages, such as being flexible with regard to different patient topographies, and thus allowing for increased flexibility and cost-effectiveness.

### SUMMARY

Accordingly, embodiments of the present invention preferably seek to mitigate, alleviate or eliminate one or more deficiencies, disadvantages or issues in the art, such as the above-identified, singly or in any combination by providing a dental implant, kit of such implants, a method of manufacturing the dental implant, a method of producing a dental installation comprising such a dental implant, and a method of installing such a dental implant in an oral cavity of a patient, according to the appended patent claims.

According to a first aspect of some embodiments of the invention, a ceramic one-piece dental implant is provided. The dental implant comprises integrally: a first portion arranged at a coronal end of the dental implant for fitting engagement with a dental restoration to the dental implant; and a second portion that contiguously adjoins the first portion at a coronal edge between the first portion and the second portion, which second portion has a width and is arranged apically from the coronal end of the dental implant; wherein a curvature including the coronal edge is adjustable by removal of material at least from the second portion while the width is substantially maintained.

The second portion may be devised for arrangement in epithelial contact with soft tissue upon implantation of the dental implant.

According to a second aspect of some embodiments of the invention, a kit of a dental implant and a tool for insertion thereof is provided. The dental implant has a flat surface arranged coronally of the dental implant. The tool has a flat surface arranged apically to matingly engage the flat surface of the dental implant for rotationally locking the tool to the dental implant.

According to a third aspect of some embodiments of the invention, a kit comprising a plurality of dental implants according to the first aspect of some embodiments of the invention is provided. The dental implants of the kit have at least a different second portion and/or third portion. As the second portion is adjustable to patient topography, thanks to the removability of material therefrom, a versatile kit having a limited number of dental implants is provided for a variety of patient situations.

According to a fourth aspect of some embodiments of the invention, a method of producing a ceramic one-piece dental implant according to the first aspect of some embodiments of the invention is provided. The method comprises producing a dental implant with a first portion arranged at a coronal end of the dental implant for fitting engagement with a dental restoration to the dental implant, a second portion that contiguously adjoins the first portion at a coronal edge of a shoulder arranged apically from the coronal end of the dental implant, a third portion contiguously adjoining the second portion apically, devised for arrangement in connective tissue upon the implantation, and a fourth portion contiguously adjoining the third portion apically towards an apical end of the dental implant, devised for arrangement in bone tissue upon the implantation.

The second portion may be devised for arrangement in epithelial contact with soft tissue upon implantation of the dental implant.

According to a fifth aspect of some embodiments of the invention, a method of producing a dental installation comprising a ceramic one-piece dental implant according to the first aspect of some embodiments of the invention, and a dental restoration, is provided. The method comprises producing the dental restoration such that it is fittingly engageable with a first portion of the dental implant and in dependence of an adjusted curvature of a second portion of the dental implant. The dental implant may be manufactured according to the method according to the fourth aspect of some embodiments of the invention.

According to a sixth aspect of some embodiments of the invention, a method of installing a ceramic one-piece dental implant in an oral cavity of a patient is provided. The method comprises arranging a second portion of the dental implant in epithelial contact with soft tissue; wherein the second portion contiguously adjoins a first portion at a coronal edge, which second portion has a width and is arranged apically from an coronal end of the dental implant, and which first portion is arranged at the coronal end of the dental implant for fitting engagement with a dental restoration to the dental implant; and adjusting a curvature including the coronal edge of the shoulder between the first portion and the second portion by removing material at least from the second portion while the width of the second portion is substantially maintained.

The method may comprise arranging the second portion of the dental implant in epithelial contact with soft tissue.

Further embodiments of the invention are defined in the dependent claims, wherein features for the second and subsequent aspects of some embodiments of the invention are as for the first aspect mutatis mutandis.

Some embodiments of the invention provide for flexibility with regard to different patient topographies.

Some embodiments provide dental implants which facilitate removal of excess dental cement or bonding agent, as well as formation of pockets containing the latter.

Some embodiments provide for a plurality of dental implants having basic geometries and adjusting allowances in order to cover a wide range of patient situations with a few basic implants.

Some embodiments of the invention also provide for advantageous aesthetics of the dental implant and a dental restoration.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

These and other aspects, features and advantages of which embodiments of the invention are capable of will be apparent and elucidated from the following description of embodiments of the present invention. The illustrated embodiments are intended to illustrate, but not to limit the inventions. The drawings contain the following figures:

FIGS. 1A, 1B, 1C are a lateral view, a frontal view and a perspective view of a dental implant, respectively;

FIG. 1D is an enlarged lateral view of the dental implant's top part of FIG. 1A;

FIGS. 2A, 2B, 2C are a lateral view, a frontal view and a perspective view of a dental implant, respectively;

FIG. 2D is an enlarged lateral view of the dental implant's top part of FIG. 2A;

FIGS. 3A, 3B, 3C are a lateral view, a frontal view and a perspective view of a dental implant, respectively;

FIG. 3D is an enlarged lateral view of the dental implant's top part of FIG. 3A;

FIGS. 4A, 4B, 4C are a lateral view, a frontal view and a perspective view of a dental implant, respectively;

FIG. 4D is an enlarged lateral view of the dental implant's top part of FIG. 4A; and

FIGS. 5A-5D are lateral views, each showing a dental implant and a tool for rotational locking thereto, respectively.

### DETAILED DESCRIPTION

Specific embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

The following description focuses on embodiments of the present invention applicable to a dental implant and in particular to a one-piece ceramic dental implant. However, it will be appreciated that the invention is not limited to the embodiments focused on in this application.

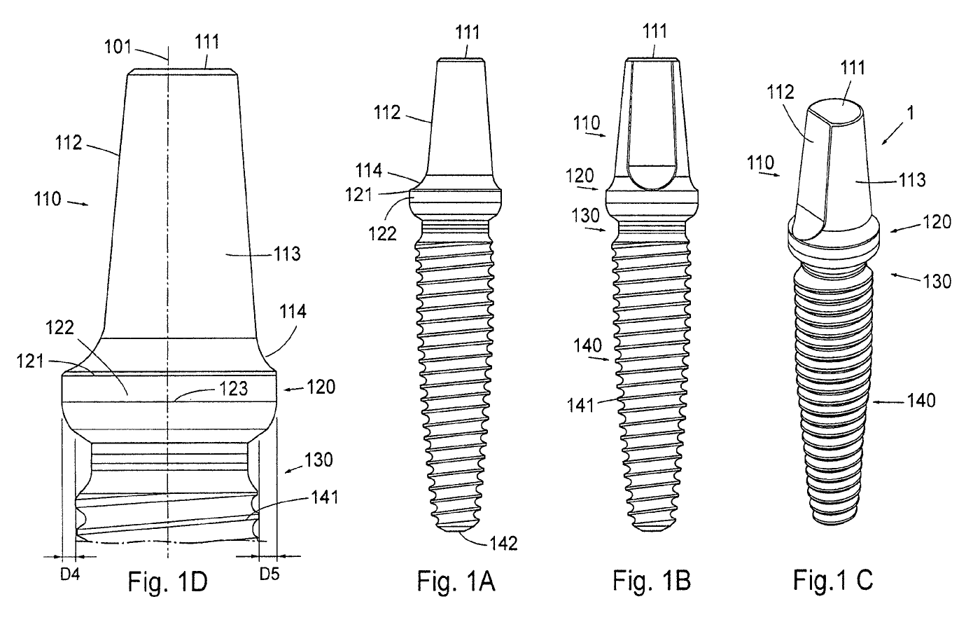

Now turning to the Figures, an embodiment of a one-piece ceramic dental implant 1 is illustrated in FIGS. 1A-1D. The dental implant 1 comprises integrally: a first portion 110 arranged at a coronal end 111 of the dental implant 1 for fitting engagement with, attachment to, or connection to a dental restoration (not illustrated) to the dental implant 1; and a second portion 120 that contiguously adjoins the first portion 110 at a coronal edge 121 of a shoulder arranged apically from the coronal end 111 of the dental implant 1, wherein the second portion 120 is devised for arrangement in epithelial contact with soft tissue upon implantation of the dental implant 1; a third portion 130 contiguously adjoining the second portion 120 apically, devised for arrangement in connective tissue upon the implantation; and a fourth portion 140 contiguously adjoining the third portion apically towards an apical end 142 of the dental implant, devised for arrangement in bone tissue upon the implantation.

The third portion 130 is provided with an outer surface that has a surface roughness that is rougher than that of an outer surface of the second portion 120 of dental implant 1. The rougher surface of the third portion 130 is thus more suitable for integration with connective tissue upon implantation.

The second portion 120 has a smoother outer surface than the third portion 130 and/or the fourth portion 140, which for instance is achieved by a ceramic surface that is machined prior to sintering the dental implant 1.

The fourth portion has an outer surface that has a rougher surface roughness than the second portion 120.

The surface roughness of the third portion 130 and the fourth portion 140 may be provided as a porous coating such as disclosed in WO2005/027771 of the same applicant as the present application. This surface is commercially known as the Ziunite® surface.

A beveled portion 114 including the coronal edge 121 of the shoulder between the first portion 110 and the second portion 120 is adjustable by removal of material from the second portion 120 to maintain a height corresponding to the surrounding soft tissue, and in such a manner that the fitting engagement with the dental restoration is preserved. The second portion 120 is shoulder formed and has a width. This width is substantially maintained when removing material therefrom due to the design of the second portion 120.

The dental implant 1 will now be described in more detail. The dental implant 1 is made in one-piece of a ceramic material, such as zirconia or alumina, and is divided into a plurality of portions as a result of different functions of these portions.

The first portion 110 at the coronal end 111 of the dental implant 1 is devised for attachment to, connection to, or fitting engagement with a dental restoration, such as a prosthetic restoration, a single crown or a bridge to the dental implant 1. The dental restoration is attached to the dental implant 1 after implantation of the dental implant 1 in surrounding bone tissue and soft tissue. Attachment of the dental restoration is usually made by using a suitable adhesive material, such as dental cement or bonding agent.

The first portion 110, to which the dental restoration is to be fixed, comprises the beveled portion 114 for forming edge portions of the dental implant 1. The upper portion of the first portion 110 has a reduced diameter, forming a frusto conically shaped unit for attaching a dental restoration or for receiving an insertion tool. The frusto conical shaped unit has a circumference composed of a partly conical exterior surface 113 and a substantially flat external surface 112 that is oriented substantially parallel to a longitudinal axis of the dental implant 1. The first portion 110 of the dental implant 1 is thus adapted to fit a dental restoration, such as a prosthetic restoration, a single crown or a bridge.

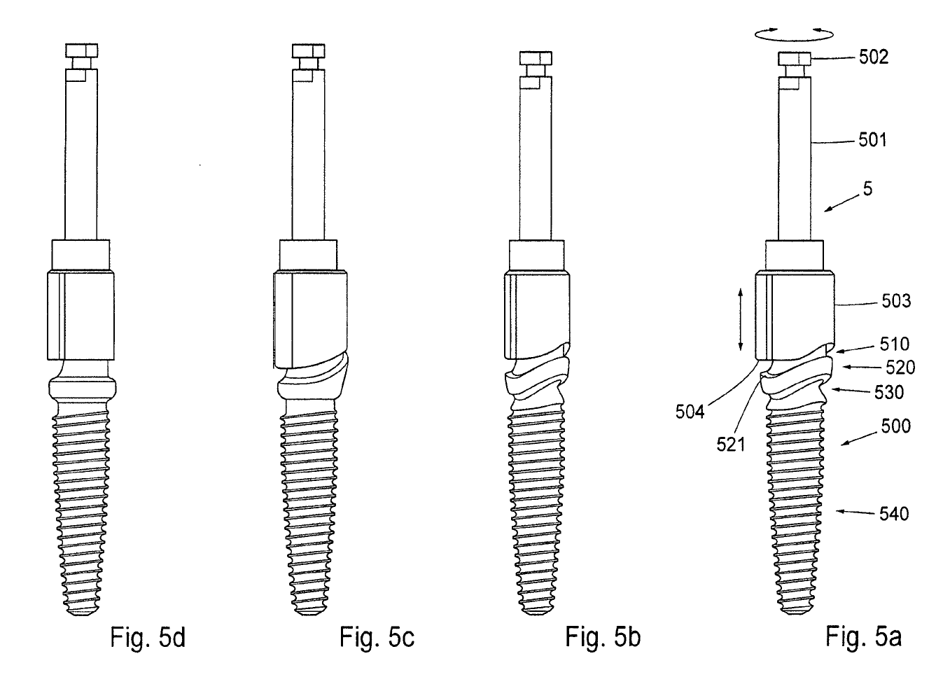

The flat surface 112 serves several purposes. It serves as a non-circular feature to provide for torque transmission during installation cooperation with an insertion tool, see FIG. 5. Furthermore, it is oriented to increase an angle of deflection for angled implants, i.e. wherein a dental restoration is arranged on the first portion 110 in a direction deviating from the longitudinal axis of dental implant 1. For instance, the flat surface 112 is oriented towards the outside of the oral cavity, such that an angled orientation of a crown is provideable.

In addition, the flat surface 112 gives a defined position of a final crown that is cemented onto the first portion 110 of the dental implant 1. Thanks to an inner surface of the crown matching with the outer surface of the first portion 110, comprising the flat surface 112 and a corresponding flat surface in the crown, a precise orientation of the crown in relation to the implant is provided.

In embodiments, the partly circular exterior surface 113 of the first portion of the dental implant is oriented substantially along the longitudinal axis of the dental implant. In some embodiments, the exterior surface may be inclined towards the center of the dental implant in a coronal direction. In this manner the above described angle of deflection is provideable while still maintaining a releasable attachment of a rotational tool for installation of the dental implant in a bore in the patient's jaw bone tissue.

The second portion 120, which contiguously adjoins the first portion 110 at a coronal edge 121, is arranged apically from the coronal end 111 of the dental implant 1. The coronal edge 121 is arranged between the first portion 110 and the second portion 120. Upon implantation of the dental implant 1, the second portion 120 is arranged at the border between the oral cavity and the soft tissue on top of the jaw bone tissue with edge 121 substantially following the gum line in the oral cavity. Apical edge 123 of the second portion 120 is arranged at the coronal end of the third portion 130. The second portion 120 will be in contact with epithelia of the soft tissue upon implantation. The second portion 120 has a smooth surface roughness, e.g. in order to avoid build-up of plaque. A suitable smooth surface roughness is for instance provided by machined ceramic surfaces that are not treated before or after sintering. Thus the outside surface of the second portion 120 is able to cooperate with the epithelium of the gum, while a third portion 130, described below, cooperates with the connective soft tissue of the gum. Thus plaque deposits are limited and bonding with the epithelial soft tissue and connective soft tissue are provided. In addition removal of excess dental cement or bonding agent is facilitated, as the second portion 120 is readily accessible even after implantation. Excess dental cement or bonding agent that may have flown to the second portion 120 from the interfacing gap between a crown and the first portion 110, is easily removed by removal methods and with removal tools that are familiar to dental care personnel.

The dental implant's 1 second portion 120 comprises a portion 122 that extends apically from the coronal edge 121 in parallel to a longitudinal axis 101 of the dental implant 1, substantially straight, towards the apical edge 123. The second portion 120 is substantially straight and extends apically from the coronal edge 121 along an entire annular circumference of the dental implant 1. The curvature is adjustable along the entire circumference of the dental implant 1 by removal of material from the substantially straight second portion 120 in dependence of a topography of the soft tissue surrounding the substantially straight second portion 120 upon implantation of the dental implant 1.

The curvature of the coronal edge 121 of the shoulder between the first portion's 110 beveled portion 114 and the second portion 120 is adjustable by removal of material from the second portion 120, in order to maintain a desired height corresponding to the surrounding soft tissue and such that the fitting engagement with the dental restoration is preserved. The second portion 120 is shoulder formed and has a width. This width is substantially maintained when removing material therefrom due to the design of the second portion 120.

Adjustment of the curvature of the dental implant is made by suitable material removal processes, such as grinding, known from preparation processes of ceramic materials. Both the topography of soft tissue and the positioning of the dental implant in bone tissue are individual for each implant and patient. For instance, the dental implant is inserted into the bone tissue into a pre-prepared recess or bore in the bone tissue. The bore is for instance prepared by means of a drill guide. The position of the bore is pre-planned and depends on various parameters, such as existing bone topography, position of nerves, blood vessels, bone cavities, etc.

The coronal edge 121 of beveled portion 114 is desired to have a curvature that coincides with the border between the oral cavity and the soft tissue. When having two-piece implants an adjustment of this border may be made by means of a specifically chosen abutment spacer, as mentioned in the background section.

Thanks to the adjustable curvature, the border may be adapted to the specific patient topography and implant situation. Adjustment may be made in the oral cavity upon implantation of the dental implant 1, or prior to implantation, based on a patient model or software planning.

Adjustment of the ceramic dental implant 1 may be made by preparation techniques known from conventional preparing of ceramic dental restorations. Preparation kits including suitable tools for adjusting the curvature to the patient specific situation are for instance commercially available as the Nobel Biocare Procera® Preparation Kit #32717.

After implantation, an impression of the dental implant 1 in the oral cavity may be taken. From the impression suitable data may be acquired for production of a dental restoration to be fitted to the dental implant 1 e.g. by three dimensional (3D) scanning of the impression, or a model cast from the impression. Alternatively to making an impression, a 3D scanning method may be used to acquire 3D data directly from the dental implant 1, and in particular of the first portion 110 and the beveled portion 114 thereof, including the coronal edge 121 of the dental implant 1, which is adapted to the specific patient situation. Suitable touch probe scanners comprise for instance the Procera® Forte scanner or the Procera® Piccolo scanner, provided by Nobel Biocare. Alternatively, a 3D optical scanner may be used to acquire the data, either from the prepared dental implant 1 prior to implantation, or in the oral cavity after implantation thereof.

The impression data thus obtained may be used for production of a dental restoration to be fitted to the dental implant 1 after implantation, and perhaps after a healing and osseointegration phase. Until delivery of the final dental restoration, a temporary restoration may be fitted to the first portion 110. The final dental restoration is attached to the dental implant 1 by suitable techniques, e.g. bonding or cementation.

A high degree of integration may thus be obtained between the epithelium and the outer surface of the second portion 120. Furthermore, an advantageous aesthetic result may also be achieved and maintained in this way, as the ceramic dental implant is not visible, but hidden in the mucosa. Moreover, the dental implant 1, if visible anyway, may be provided in a color similar to the dental restoration, and thus the aesthetic appearance of the completed dental installation is advantageous.

The third portion 130 contiguously adjoining the second portion 120 apically will be arranged in connective soft tissue upon implantation of the dental implant 1. The third portion 130 is waist shaped or inwardly narrowed providing soft tissue stabilization. The third portion 130 ends apically at the border between soft tissue and bone tissue, where the fourth portion 140 adjoins the third portion 130.

The soft tissue stabilization may be further improved by adding a textured surface in the waist region. The surface roughness of an outer surface of the third portion 130 is thus rougher than the surface roughness of an outer surface of the second portion 120. One example of such a surface is a porous coating as disclosed in WO2005/027771 of the same applicant as the present application, which hereby is incorporated herein in its entirety. The porous or rough surface disclosed in WO2005/027771 that originally provides improved osseointegration of the threaded part of a ceramic dental implant, corresponding to the fourth portion 140 described below. However, the porous surface also improves integration with connective soft tissue along the surface of the third portion 130 of the dental implant 1. Hence, such a porous surface structure may be provided on the third portion 130 and the fourth portion 140.

Further measures for increasing integration of the dental implant 1 with the connective soft tissue may be provided in combination with the inwardly narrowed or waist shaped part, for example in the form of grooves or depressions in the inwardly narrowed or waist-shaped part.

A high degree of integration may thus be obtained between the connective soft tissue and the outer surface of the third portion 130.

The fourth portion 140 contiguously adjoining the third portion apically towards an apical end 142 of the dental implant will be arranged in bone tissue upon the implantation. The fourth portion 140 is also called fixture portion of the dental implant 1. A thread 141 formed on the fourth portion provides mechanical attachment of the dental implant 1 into a bore of surrounding bone tissue.

Dental implant 1 is suitable to be positioned at a posterior position of the jaw along the dental arch. Alternatively, dental implant 1 may be a general use implant suitable for implantation at various positions along the dental arch.

Below, further embodiments will be described, which mainly differ from the above described embodiment by different second portions. Elements belonging to similar portions or section of the dental implant are provided with reference numerals that have an identical ending, but a leading number corresponding to the specific dental implant, respectively. For instance the flat surface 212, 312, 412 corresponds to the flat surface 112. However, as becomes clear from the attached Figures, the elements may have a different design, depending on the specific embodiment.

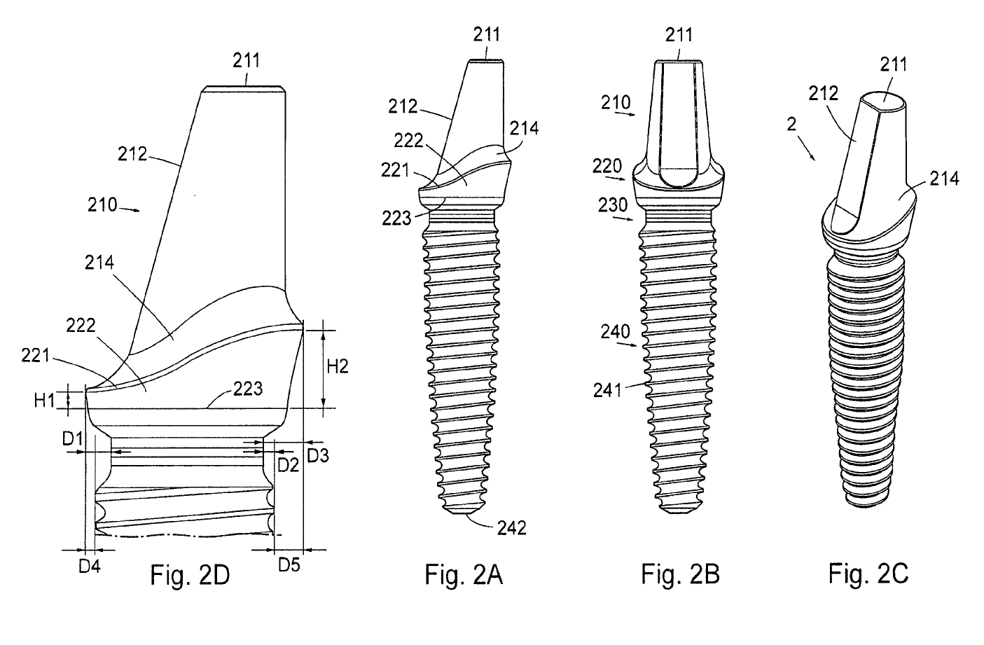

A second embodiment of a dental implant is illustrated in FIGS. 2A, 2B, 2C, and 2D. The dental implant 2 comprises integrally: a first portion 210 arranged at a coronal end 211 of the dental implant 2 for fitting engagement with a dental restoration (not illustrated) to the dental implant 2, and comprises a straight surface 212 having a similar function as surface 112 of dental implant 1; and a second portion 220 that contiguously adjoins the first portion 210 at a coronal edge 221 of a shoulder arranged apically from the coronal end 211 of the dental implant 2, wherein the second portion 220 is devised for arrangement in epithelial contact with soft tissue upon implantation of the dental implant 2; a third portion 230 contiguously adjoining the second portion 220 apically, devised for arrangement in connective tissue upon the implantation; a fourth portion 240 contiguously adjoining the third portion apically towards an apical end 242 of the dental implant, comprises a thread 241 and is devised for arrangement in bone tissue upon the implantation.

A beveled portion 214 including the coronal edge 221 of the shoulder between the first portion 110 and the second portion 220 is adjustable by removal of material from the second portion 220 to obtain a height thereof, corresponding to surrounding soft tissue, and such that the fitting engagement with the dental restoration is preserved. This may be done by removing material substantially in parallel to the longitudinal axis of the dental implant 2. As can be seen in FIG. 2, the second portion 220 is shoulder formed and has a slightly varying width along the longitudinal axis of the dental implant 2. This width is substantially maintained when removing material therefrom due to the design of the second portion 220. Alternatively or additionally, a dental impression of the dental implant 2 may be made in order provide an adaptation of an inner surface of a crown to be affixed to the first portion 210 for matching the patient customized beveled portion 214.

The second portion 220 of dental implant 2 has a straight apical edge 223 oriented substantially perpendicular to the longitudinal axis of the dental implant 2 at the transition to the waist portion of the dental implant 2. A coronal edge 221 at the border from the first portion 210 to the second portion 220 is curved, as well as the beveled portion 214. More precisely, the coronal edge 221, is scalloped having a valley and a peak. The beveled portion 214 is beveled towards the coronal end 211, from the maximum diameter of the shoulder that forms the adjustable portion 222 of the first portion 210. Thus, an adjustable portion 222 is provided for specific patient situations. The adjustable portion 222 has a certain height along which excess dental cement in an advantageous way may run down, and subsequently be easily removed.

Dental implant 2 is suitable to be positioned at a posterior position of the jaw along the dental arch. Alternatively, dental implant 1 may be a general use implant suitable for implantation at various positions along the dental arch.

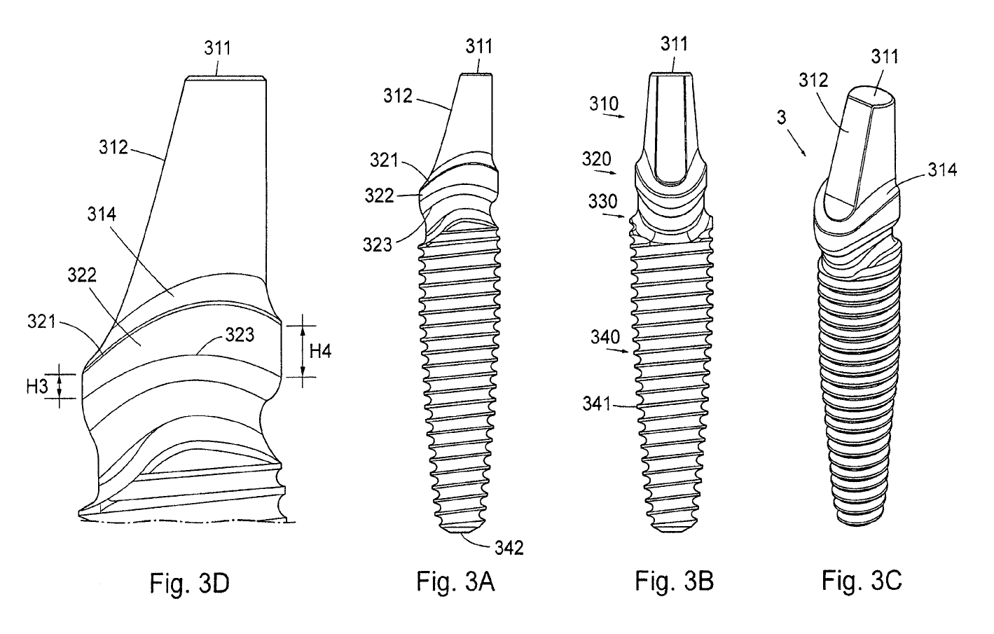

In another embodiment of the invention according to FIGS. 3A, 3B, 3C, and 3D a dental implant 3 is provided. A one-piece ceramic dental implant 3 is illustrated in FIGS. 3A-3D. The dental implant 3 comprises integrally: a first portion 310 arranged at a coronal end 311 of the dental implant 3 for fitting engagement with a dental restoration (not illustrated) to the dental implant 3; and a second portion 320 that contiguously adjoins the first portion 310 at a coronal edge 321 of a shoulder arranged apically from the coronal end 311 of the dental implant 3, wherein the second portion 320 is devised for arrangement in epithelial contact with soft tissue upon implantation of the dental implant 3; a third portion 330 contiguously adjoining the second portion 320 apically, devised for arrangement in connective tissue upon the implantation; a fourth portion 340 contiguously adjoining the third portion apically towards an apical end 342 of the dental implant, devised for arrangement in bone tissue upon the implantation.

A beveled portion 314 including the coronal edge 321 of the shoulder between the first portion 310 and the second portion 320 is adjustable by removal of material from the second portion 320 to maintain a height thereof, corresponding to surrounding soft tissue, and such that the fitting engagement with the dental restoration is preserved. As described above, this may be done by removing material substantially in parallel to the longitudinal axis of the dental implant 3. As the shoulder formed second portion 320 of dental implant 3 has a defined width, this width is maintained when removing material therefrom. Alternatively or additionally, a dental impression of the dental implant 3 may be made in order provide an adaptation of an inner surface of a crown to be affixed to the first portion 310 for matching the patient customized beveled portion 314.

Dental implant 3 has a scalloped adjustable surface 322 having at least one peak and at least one valley. The apical edge 323 at the transition to the waist of the dental implant 3 as well as the coronal edge 321 at the border from the first portion 310 to the second portion 320 are both scallopedly curved, as well as the beveled portion 314. Thus an adjustable portion 322 is provided for specific patient situations. The diameter of the second portion 320 is smaller than the diameter of the fourth portion 340, such that implant 3 is suited for insertion into tight spaces.

The shoulder formed second portion 320 of dental implant 3 has a diameter that does not exceed the outer diameter of the thread 341 of the fourth portion 340. Thus, installation of the dental implant 3 is facilitated, as the shoulder does not hinder the implant from being screwed into a pre-prepared bore in patient bone tissue. The shoulder does not engage a crest of the bore, in case it should be desired to countersink the implant at least partly with the second portion 320 into the bore, beyond the crest.

Dental implant 3 is suited to be positioned at a lateral incisor position of the jaw along the dental arch.

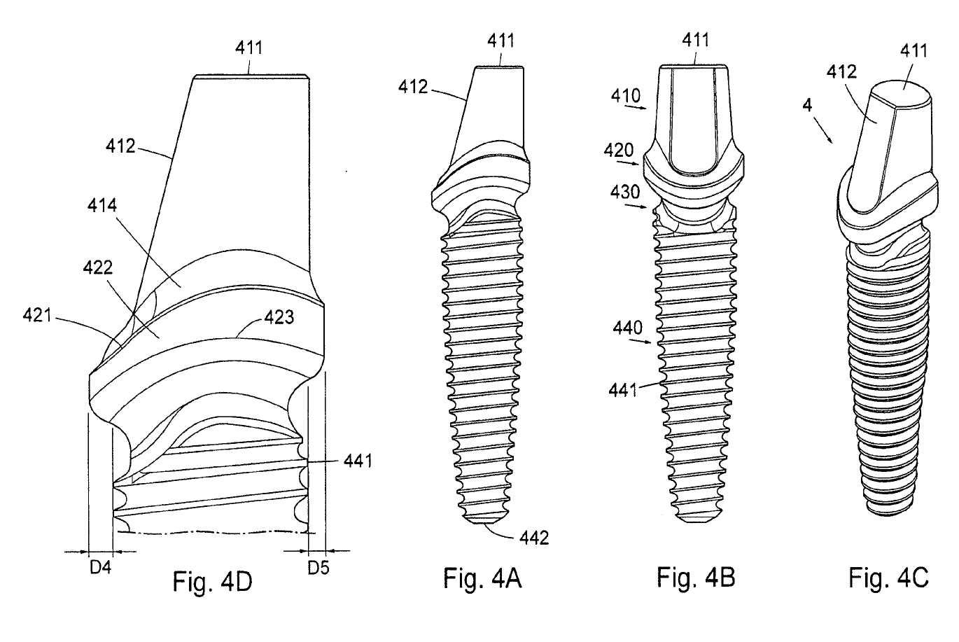

FIGS. 4A, 4B, 4C, and 4D illustrate a further embodiment of a dental implant 4. A one-piece ceramic dental implant 4 is illustrated in FIGS. 4A-4D. The dental implant 1 comprises integrally: a first portion 410 arranged at a coronal end 411 of the dental implant 4 for fitting engagement with a dental restoration (not illustrated) to the dental implant 4; and a second portion 420 that contiguously adjoins the first portion 410 at a coronal edge 421 of a shoulder arranged apically from the coronal end 411 of the dental implant 4, wherein the second portion 420 is devised for arrangement in epithelial contact with soft tissue upon implantation of the dental implant 4; a third portion 430 contiguously adjoining the second portion 420 apically, devised for arrangement in connective tissue upon the implantation; a fourth portion 440 contiguously adjoining the third portion apically towards an apical end 442 of the dental implant, devised for arrangement in bone tissue upon the implantation.

A beveled portion 414 including the coronal edge 421 between the first portion 410 and the shoulder formed second portion 420 is adjustable by removal of material from the second portion 420. Thanks to the design of the dental implant 4, a height or curvature of the second portion 420 may be adjusted, corresponding to the height or curvature of surrounding soft tissue. Still, the fitting engagement with the dental restoration is preserved after material removal from the second portion 420.

More precisely, the second portion 420 of dental implant 4 has a scalloped adjustable surface 422. The scalloped adjustable surface 422 has two peaks and valleys, one coronally and one apically, respectively. The lower edge 423 at the transition to the waist of the dental implant 4 as well as the upper edge 421 at the border from the first portion 410 to the second portion 420 are both curved, as well as the beveled portion 414. The second portion 420 extends with an exterior surface thereof straight in longitudinal direction of dental implant 4, between the upper edge 421 and the lower edge 423. Thus an adjustable portion 422 having a scalloped shape with two peaks and valleys is provided for specific patient situations. The diameter of the second portion 420 is larger than the maximum outer diameter of the thread 441 of the fourth portion 440, such that the shoulder provided by the form of the second portion 420 protrudes over the outer boundary of the fourth portion 440, seen in longitudinal direction.

The maximum outer diameter of the shoulder formed second portion 420 exceeds thus the diameter of a coronal end of a final preparatory instrument for the bore. When inserting the dental implant 4 in a pre-prepared bore, the dental implant may thus bar against the crest of the bore in the jaw bone tissue. In order to avoid this situation and in order to facilitate insertion of the dental implant 4 into a bore, the coronal end of the thread 441 of the fourth portion 440 has to fulfill the following requirement. The coronal end of the thread should be located apically of an intersection point between the marginal edge of the preparation and the coronal external boundary surface of the waist. In this manner, it is avoided that the implant is screwed such far into the prepared bore that the coronal portion of the waist portion abuts against the crest of the bore or the surrounding jaw bone tissue. If this requirement is fulfilled, the shoulder formed portion 420 of the dental implant 4 does not limit the rotational movement 420 of the dental implant 4 upon implantation. This applies mutatis mutandis to all embodiments where the maximum outer diameter of a shoulder formed portion exceeds the maximum final diameter of a prepared bore.

Dental implant 4 is suited to be positioned at a central incisor position of the jaw along the dental arch.

In some embodiments, such as the embodiments illustrated in FIGS. 2A-2D, 3A-3D, and 4A-4D, first portion 210, 310, 410 is angled relative the longitudinal axis of the implant. The first unit may comprise the frusto conical shaped unit having a vertical axis. The vertical axis may me angled relative the longitudinal axis of the dental implant such that a circular part of the exterior surface of the frusto conical shaped unit is at least at a portion substantially parallel to the longitudinal axis of the dental implant. The flat surface is arranged to further increase the angulation of the first portion relative the longitudinal axis of the dental implant compared to the circular part of the exterior surface of the frusto conical unit.

The following dimensions of dental implants are disclosed herein, wherein a number of examples are given below without limiting the scope of the present invention:

D1: depth of waist at the smallest diameter thereof, measured from the outmost point of the shoulder of the dental implant. In some embodiments, D1 may have dimensions in the range of 0.3 mm to 1 mm, such as 0.35 mm or 0, 85 mm.

D2: depth of waist at the smallest diameter thereof, measured from the point where the straight portion of the shoulder transitioning to a curved part of the waist of a dental implant of some embodiments. In some embodiments, D2 may have dimensions in the range of 0.44 mm to 0.66 mm, such as mm.

D3: depth of waist at the smallest diameter thereof, measured from the outmost point of the shoulder of the second portion of the dental implant. In some embodiments, D3 has approximately the same dimensions as D1.

D4: depth of the shoulder measured from the outmost point of the shoulder of the second portion of the dental implant to the tip of the thread of the fourth portion of the dental implant, measured at the lowest point of the shoulder. In some embodiments, D4 may have dimensions in the range of 0.4 mm to 0.6 mm, such as 0.5 mm.

D5: depth of the shoulder measured from the outmost point of the shoulder of the second portion of the dental implant to the tip of the thread of the fourth portion of the dental implant, measured at the top point of the shoulder. In some embodiments, D5 may have dimensions in the range of 0.4 mm to 0.6 mm, such as 0.5 mm.

H1: smallest height of the straight portion of the second portion of the dental implant. In some embodiments, H1 may have dimensions in the range of 0.3 mm to 0.5 mm, such as 0.4 mm.

H2: largest height of the straight portion of the second portion of the dental implant. In some embodiments, H2 may have dimensions in the range of 1.2 mm to 1.8 mm, such as 1.5 mm.

H3: smallest height of the straight portion of a scalloped second portion of the dental implant. In some embodiments, H3 may have dimensions in the range of 0.6 mm to 1 mm, such as 0.8 mm.

H4: largest height of the straight portion of a scalloped second portion of the dental implant. In some embodiments, H4 may have dimensions in the range of 0.8 mm to 1.5 mm, such as 1.2 mm.

The second portion of dental implants may according to embodiments have a height 0.2 mm to 2 mm, such as 1.6 mm, and protrudes between 0.1 mm to 1 mm, such as 0.4 mm from the innermost diameter of the third portion.

In FIG. 5A a dental implant 500 and a tool 5 for rotational locking thereto are illustrated. The dental implant 500 has a second portion that corresponds to the dental implant 4 describe with reference to FIG. 4.

A shaft 501 of tool 5 comprises a coronal attachment point 502, for attachment to a suitable operational tool rotationally driving shaft 501. A sleeve 503 is configured to be pushed over the first portion 510 of dental implant 500, abutting against edge 521 of the dental implant 500 with the apical edge 504 of the sleeve 503 of tool 5. The inner of sleeve 503 has mating surfaces with the outer surface of the first portion 510. Dental implant 500 comprises further a second portion 520, a third portion 530 and a fourth portion 540, similar to the corresponding portion of the embodiments described above. In this manner the dental implant 500 may be advantageously and efficiently brought into rotation as the tool 5 is rotationally locked to the dental implant 500, both by the flat surface and by the mating edges 504 and 521, respectively.

Further implants having differently formed second portions, and tools having different corresponding sleeves, are illustrated in FIGS. 5B-D. The implant shown in FIG. 5B corresponds to the dental implant 3. The implant shown in FIG. 5C corresponds to the dental implant 2, and the implant shown in FIG. 5D corresponds to the dental implant 1.

As used herein, the singular forms “a”, “an” and “the” are intended to include the plural forms as well, unless expressly stated otherwise. It will be further understood that the terms “includes,” “comprises,” “including” and/or “comprising, “when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention has been described above with reference to specific embodiments. However, other embodiments than the above described are equally possible within the scope of the invention as defined by the attached patent claims.

In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

1. A ceramic one-piece dental implant comprising integrally:
a first portion arranged at a coronal end of said dental implant for fitting engagement with a dental restoration to said dental implant; and
a second portion that contiguously adjoins said first portion at a coronal edge between said first portion and said second portion, which second portion has a width and is arranged apically from said coronal end of said dental implant;
wherein a curvature including said coronal edge is adjustable by removal of material at least from said second portion while said width is substantially maintained.

2. The dental implant according to claim 1, further comprising a waist shaped third portion contiguously adjoining said second portion apically, devised for arrangement in connective tissue upon said implantation, and wherein said second portion is devised for arrangement in epithelial contact with soft tissue upon implantation of said dental implant.

3. The dental implant according to claim 1, wherein said second portion comprises a substantially straight portion that extends apically from said coronal edge at least partly in parallel to a longitudinal axis of said dental implant.

4. The dental implant according to claim 3, wherein said substantially straight portion extends apically from said coronal edge in parallel to a longitudinal axis of said dental implant along an entire circumference of said dental implant.

5. The dental implant according to claims 1, further comprising a fourth portion contiguously adjoining said third portion apically towards an apical end of said dental implant, devised for arrangement in bone tissue upon said implantation.

6. The dental implant according to claim 5, wherein said third portion and/or said fourth portion have a roughened surface for improving integration with connective tissue or osseointegration of said dental implant upon implantation.

7. The dental implant according to claims 2, wherein said second portion has an external surface, in use oriented towards said soft tissue, which has a surface roughness that is less rough than a surface roughness of an external surface of said waist shaped third portion.

8. The dental implant according to claims 2, wherein said waist shaped third portion is scalloped having at least one peak and at least one valley.

9. The dental implant according to claim 1, wherein said dental implant is adjustable by removal of material at least from said second portion to obtain a height of said second portion corresponding to a height of said soft tissue at said second portion, and such that said fitting engagement of said dental restoration is preserved.

10. The dental implant according to claim 3, wherein said curvature is adjustable along said entire circumference of said dental implant by removal of material from said substantially straight portion in dependence of a topography of said soft tissue.

11. The dental implant according to claim 1, wherein said curvature is of annular form.

12. The dental implant according to claim 1, wherein said curvature is provided in form of a scallop.

13. The dental implant according to claim 12, wherein said scallop has a most apically situated point that is situated more coronally than a coronal end of a thread of said fourth portion in order to facilitate installation of said dental implant.

14. The dental implant according to claim 13, wherein said coronal end of said thread is located apically of an intersection point between a preparation for said dental implant in a patient's jaw bone and a coronal external boundary surface of said waist shaped third portion.

15. The dental implant according to claim 1, wherein said second portion has a height between 0, 2 to 2 mm, such as 1, 6 mm, and protrudes between 0.1 to 1 mm, such as 0.4 mm from a minimal diameter of said third portion.

16. The dental implant according to claim 1, wherein said first portion further comprises a flat surface arranged at said coronal end of said dental implant, wherein the first portion is angled relative the longitudinal axis of the implant, and the flat surface is arranged to further increase the angulation.

17. A kit of a plurality of dental implants according to claim 1, each of said plurality of said dental implant having at least a different second portion and/or third portion.

18. A kit of a dental implant having a flat surface arranged coronally and, and a tool having a flat surface arranged apically to matingly engage said flat surface of said dental implant for rotationally locking said tool to said dental implant.

19. A method of producing a ceramic one-piece dental implant according to claim 1, the method comprising:
producing said dental implant with a first portion arranged at a coronal end of said dental implant for fitting engagement with a dental restoration to said dental implant, a second portion that contiguously adjoins said first portion at a coronal edge of a shoulder arranged apically from said coronal end of said dental implant, a third portion contiguously adjoining said second portion apically, devised for arrangement in connective tissue upon said implantation, and a fourth portion contiguously adjoining said third portion apically towards an apical end of said dental implant, devised for arrangement in bone tissue upon said implantation.

20. The method according to claim 19, further comprising adjusting a curvature including said coronal edge of said shoulder between said first portion and said second portion by removing of material from said second portion to obtain a height said second portion corresponding to a height of said soft tissue, and wherein said second portion is devised for arrangement in epithelial contact with soft tissue upon implantation of said dental implant.

21. The method according to claim 19, further comprising machining an external surface of said second portion prior to sintering said dental implant.

22. The method according to claim 21, further comprising roughening an external surface of said third portion and/or an external surface of said fourth portion such that said external surface of said third portion and/or said external surface of said fourth portion have a surface roughness that is rougher than a surface roughness of said external surface of said second portion.

23. A method of producing a dental installation comprising a ceramic one-piece dental implant according to claim 1, and a dental restoration, said method comprising producing said dental restoration such that it is fittingly engageable with a first portion of said dental implant and in dependence of an adjusted curvature of a second portion of said dental implant.

24. The method according to claim 23, wherein said dental implant is manufactured according to claim 19.

25. A method of installing a ceramic one-piece dental implant in an oral cavity of a patient, the method comprising
arranging a second portion of said dental implant in contact with soft tissue; wherein said second portion contiguously adjoins a first portion at a coronal edge, which second portion has a width and is arranged apically from an coronal end of said dental implant, and which first portion is arranged at said coronal end of said dental implant for fitting engagement with a dental restoration to said dental implant; and
adjusting a curvature including said coronal edge of a shoulder between said first portion and said second portion by removing material at least from said second portion while said width of said second portion is substantially maintained.

26. The method according to claim 25, wherein said second portion is arranged at a border between the oral cavity and the soft tissue on top of a jaw bone tissue with the coronal edge substantially following a gum line in the oral cavity.

27. The method according to claim 25, comprising arranging a third portion contiguously adjoining said second portion apically in connective soft tissue, and arranging said second portion in epithelial contact with soft tissue.

28. The method according to claim 27, further comprising stabilizing said connective soft tissue by a waist shape or inwardly narrowed portion of said third portion.

29. The method according to claim 28, further improving soft tissue stabilization by a textured surface in said waist shape or inwardly narrowed portion.
